(19) United States
(12) Patent Application Publication
(10) Pub. No.: US 2009/0147152 A1
(43) Pub. Date: Jun. 11, 2009

(54) LIGHTING SYSTEM AND PROJECTION TYPE VIDEO DISPLAY APPARATUS UTILIZING THE SAME

(75) Inventor: Koji Ishii, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 12/302,116

(22) PCT Filed: Apr. 4, 2007
(86) PCT No.: PCT/JP2007/057578

§ 371 Date: Nov. 24, 2008

(30) Foreign Application Priority Data
May 31, 2006 (JP) 2006-151006

(51) Int. Cl. H04N 5/44; G02B 5/30

(52) U.S. Cl. 348/744; 359/495; 359/497

(57) ABSTRACT

A lighting system requiring no precision adjustments thereof and having reduced luminance inhomogeneity is provided, along with a projection type video display apparatus utilizing such lighting system. The lighting system has: a multiplicity of light sources (1a and 1b) for emitting substantially parallel beams of light; and a light-path alteration unit (2) having light splitting members (3a and 3b) for reflecting one half of substantially parallel beams of light emitted from the respective light sources (1a and 1b) and transmitting therethrough the other half beams of light, thereby collimating the light from the respective light sources (1a and 1b) in one direction to uniformly irradiate the entire irradiation surface (incidence face) of an integrator lens (71).

### TECHNICAL FIELD

This invention relates to a lighting system and a projection type video display apparatus utilizing the lighting system.

### BACKGROUND ART

There has been known a projection type video display apparatus in the form of a liquid crystal projector, for example, adapted to illuminate liquid crystal panels with intense beams of light emitted from a lighting system to project the image formed on the liquid crystal panels on a screen.

A typical lighting system for use with this type of projection type video display apparatus is disclosed in Patent Document 1 listed below, which is shown in FIG. 5. The lamps of the light sources are omitted in this figure (as in the rest of figures). This lighting system comprises a multiplicity of small low-power light sources to simulate a point light source. As a result, the low-power lighting system has an improved lighting efficiency.

Briefly stated, this lighting system has an array of light sources 1a and 1b emitting substantially parallel beams of light in the same direction. The beams are once focused by a convex lens 101 and then collimated to parallel beams of light by means of a collimating lens 102 before they are directed to an integrator lens 71. The beams of light from each of the light sources 1a and 1b selectively illuminate one half incidence domain of the integrator lens 71, without overlapping on the incidence domain.

As another example, Patent Document 2 discloses a lighting system as shown in FIG. 6. This lighting system has light-path alteration members 111-113 between two light sources 1a and 1b each having a concave reflector to emit substantially parallel beams of light. Each of the light-path alteration members 111-113 has one divisional reflective surface 111a-113a for reflecting beams of light from one light source and another divisional reflective surface 111b-113b for reflecting beams of light from the other light source. The divisional reflective surfaces 111a-113a for the light sources 1a lie in different parallel planes. So are the other divisional reflective surfaces 111b-113b for the light source 1b. The beams of light reflected from the divisional reflective surfaces 111a-113a are interlaced with the beams of light reflected from the divisional reflective surfaces 111b-113b, spreading on the incidence face of the integrator lens 71 in a continuous and non-overlapping manner. The light coming from central regions of the light sources 1a and 1b illuminates central areas of the integrator lens 71, and the light coming from peripheral regions of the light sources 1a and 1b illuminates peripheral areas of the integrator lens 71.

### Patent Document 1

Japanese Patent Application Laid Open No. 2002-258212 (G02B 27/18, G03B 21/00)

### Patent Document 2

Japanese Patent Application Laid Open No. 2001-21996 (G03B 21/14, G03B 21/00)

### DISCLOSURE OF INVENTION

### Problems to be Solved by the Invention

In these lighting systems, however, in the event when the lamp of one light source has burned out, only one half domain of the integrator lens 71 is illuminated by substantially parallel beams of light emitted from the other light source, and then the integrator lens would not fully fulfill its design function to illuminate the entire surface of a liquid crystal panel, thereby resulting in luminance inhomogeneity on the liquid crystal panel. Luminance inhomogeneity also takes place when substantially parallel beams of light from the respective light sources are not correctly directed to the intended illumination domains of the integrator lens. Therefore, high-precision positioning and angular adjustment of the respective divisional reflective surfaces are required in order to reduce such luminance inhomogeneity.

It is, therefore, an object of the present invention to solve these prior art problems by providing a lighting system that requires no high-precision adjustment and yet has reduced luminance inhomogeneity.

It is another object of the invention to provide a projection type video display apparatus utilizing such lighting apparatus.

### Means for Solving the Problem

In order to achieve the objects stated above, the present invention seeks to provide a lighting system (100) as defined in claim 1, which comprises:

a multiplicity of light sources (1a and 1b) for emitting substantially parallel beams of light;

a light-path alteration unit (2) having light splitting members (3a and 3b) each adapted to reflect one half of the substantially parallel beams of light emitted from the light source associated therewith and transmit the other half of the beams therethrough, the light-path alteration unit collimating the light from the respective light sources in one direction to irradiate the entire illumination domain of a given integrator lens.

In one aspect of the invention as defined in claim 2, the lighting system (100) has:

two opposing light sources (1a and 1b) facing each other; and

the light splitting members (3a and 3b) each having a light splitting plane associated with one light source and inclined to the illumination domain such that the two light splitting planes are adjoined to have a ridge or a trough facing the illumination domain.

In a still further aspect of the invention as defined in claim 3, the light splitting members are polarization beam splitters (3a and 3b).

In a still further aspect of the invention as defined in claim 4, the lighting system (100) comprises:

a first and a second light source (1a and 1b) facing each other for emitting substantially parallel beams of light;

a first and a second PBS coat (31a and 31b) which are inclined and disposed substantially symmetric between the first and second light sources (1a and 1b), each PBS coat adapted to transmit P-polarized light emitted from the respective sources (1a and 1b) and reflect S-polarized light;

a first retardation film (4) for converting into S-polarized light the P-polarized light that has passed through the first PBS coat (31a) and the P-polarized light that has passed through the second PBS coat (31b);

a second retardation film (5) and a mirror (6) for converting into P-polarized light the S-polarized light that has been retarded by the first retardation film (4) and reflected by the second or the first PBS coat (31b or 31a), and for reflecting back the resultant P-polarized light; and

an integrator lens (71) for receiving:
the S-polarized light first reflected by the first PBS coat (31a) and first reflected by the second PBS coat (31b); and
the P-polarized light reflected from the mirror (6) coupled with the second retardation film (5) and transmitted through the second or the first PBS coat (31b or 31a),
   to thereby provide parallel beams of light having a substantially uniform intensity distribution.

In a still further aspect of the invention as defined in claim 5, the lighting system has:

a first and a second light source (1a and 1b) facing each other to emit substantially parallel beams of light;

a first and a second PBS coat (31a and 31b) which are inclined and disposed substantially symmetric between the first and second light sources (1a and 1b), each PBS coat adapted to transmit P-polarized light emitted from the respective sources (1a and 1b) and reflect S-polarized light;

a first retardation film (4) for converting into S-polarized light the P-polarized light that has passed through the first PBS coat (31a) and the P-polarized light that has passed through the second PBS coat (31b);

a second retardation film (5) and a mirror (6) for converting into P-polarized light the S-polarized light that has been retarded by the first retardation film (4) and reflected by the second or the first PBS coat (31b or 31a), and for reflecting back the resultant P-polarized light; and

an integrator lens (71) for receiving both
the S-polarized light that is converted from the P-polarized light by the first retardation film (4) and reflected by the second or the first PBS coat (31b or 31a) and
the P-polarized light that is reflected from the mirror (6) coupled with the second retardation film (5) and transmitted through the first or the second PBS coat (31a or 31b), to thereby provide substantially parallel beams of light having a substantially uniform intensity distribution.

In a still further aspect of the invention as defined in claim 6, the lighting system in accord with claims 4 and 5 may be configured as defined in claim 6 to have the first and second PBS coats (31a and 31b) inclined to each other and arranged substantially symmetric between the first and second light sources (1a and 1b).

As defined in claim 7, a projection type video display apparatus may include:

a lighting system (100) defined in any one of claims 1 through 6;

optical modulation elements (76) for modulating light emitted from the lighting system based on video signals; and

a projection lens unit (81) for projecting the light modulated by the optical modulation elements (76).

This projection type video display apparatus may be configured, as defined in claim 8, to:

split the light received from the lighting system into three beams of primary colors and direct the respective split beams to associated optical modulation elements to modulate the respective split beams;

synthesize the modulated beams; and

project the synthesized beam.

### MERITS OF THE INVENTION

A lighting system of the invention can provide light with reduced luminance inhomogeneity even in the event that any of the light sources has burnt out toward the end of its life. In contrast to a conventional lighting system in which only one half of the illumination domain (or region to be illuminated) of an integrator lens is illuminated by an associated light source, the entire illumination domain of the an integrator lens of the invention is irradiated by substantially parallel beams of light emitted from each of the light sources. As a consequence, accurate matching of the irradiation ranges of the light sources to the illumination domain of the integrator lens, and hence high-precision adjustment of the lighting system, is not required. Thus, the lighting system can be the assembled in a simple manner at a reduced cost.

Further, color heterogeneity of a projection type video display apparatus can be reduced if the inventive lighting system is utilized in the display apparatus, since the light emitted from the lighting system can be split into three beams of primary colors, directed to optical modulation elements, and synthesized to form image light before it is projected.

### BRIEF DESCRIPTION OF THE DRAWINGS

FIG. 1 shows a principal part of a lighting system in accordance with one embodiment of the invention.

FIG. 2 illustrates functions of the lighting system shown in FIG. 1.

FIG. 3 shows an arrangement and functions of a lighting system in accordance with another embodiment of the invention.

FIG. 4 shows an arrangement and functions of a liquid crystal projector utilizing the lighting system shown in FIGS. 1 and 2.

FIG. 5 shows an arrangement of a conventional lighting system.

FIG. 6 shows an arrangement of another conventional lighting system.

### NOTATIONS

1a and 1b light sources;
2 light-path alteration unit;
3a and 3b polarization beam splitter (PBS);
31a and 31b light splitting planes;
4 ½-wavelength retardation film;
5 ¼-wavelength retardation film;
6 reflector;
71 integrator lens;
74 and 77 dichroic mirrors;
75, 78, and 79 total reflection mirrors;
76R, 76G, and 76B liquid crystal panels;
80 dichroic prism;
81 projection lens unit;
100 lighting system.

### BEST MODE FOR CARRYING OUT THE INVENTION

The invention will now be described in detail by way of examples with reference to the accompanying drawings.

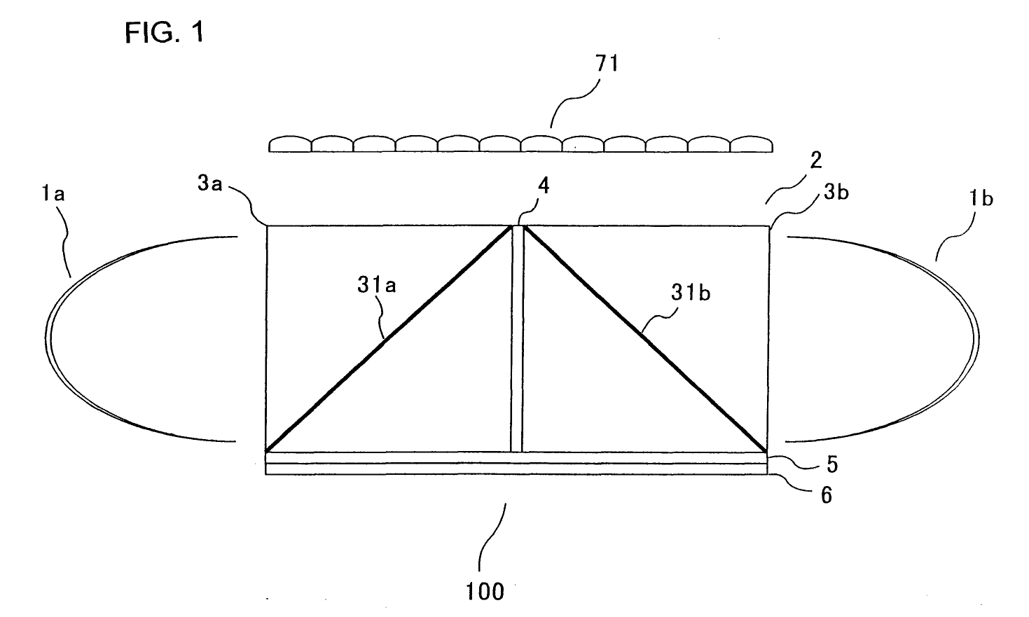

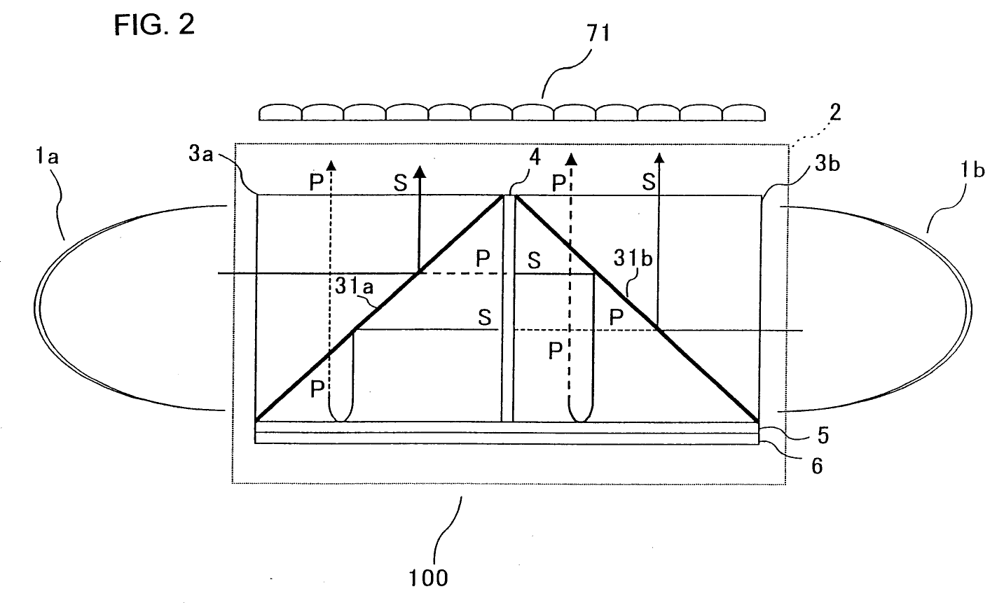

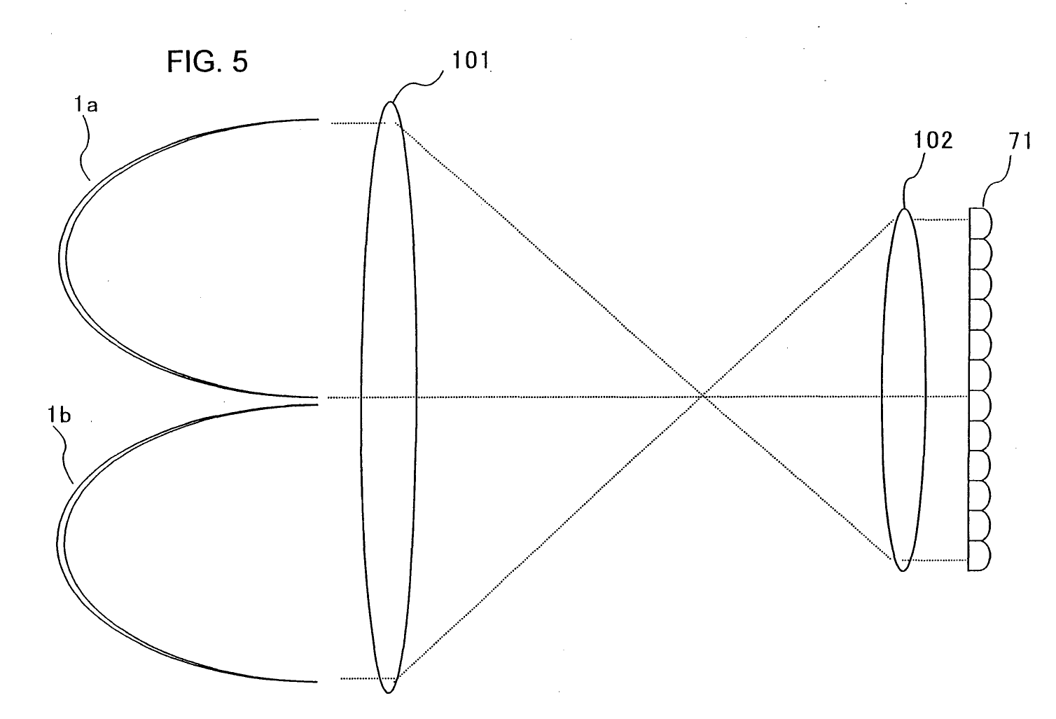

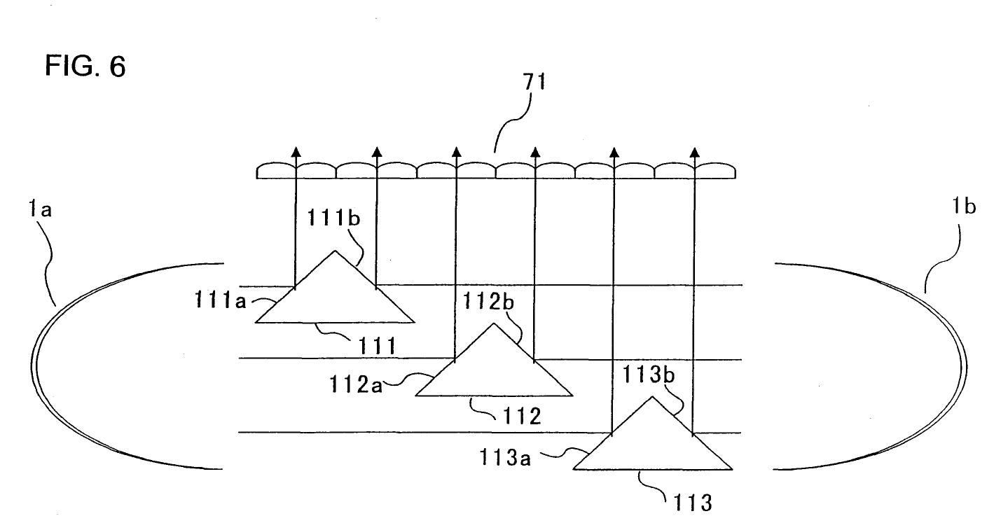

FIG. 1 shows a principal part of a lighting system 100 in accordance with one embodiment of the invention. FIG. 2 illustrates functions of the lighting system shown in FIG. 1. Those components shown in FIGS. 1 and 2, which are like or the same as shown in FIGS. 5 and 6 are respectively referred to by the same reference numerals.

As seen in FIG. 1, the lighting system 100 has a light-path alteration unit 2 between two light sources 1a and 1b arranged to face each other. The light-path alteration unit 2 includes: light splitting members in the form of cubic polarization beam splitters (PBS) 3a and 3b associated with the respective light sources 1a and 1b; a ½-wavelength retardation film 4; a ¼-wavelength retardation film 5; and a reflector 6.

In the embodiment shown herein, each of the polarization beam splitters (PBS) 3a and 3b has neighboring light splitting plane 31a and 31b, which consist of a thin layer or coat of optical material having different incident-angle-dependent reflective indices for S-polarized and P-polarized light. The light splitting planes 31a and 31b are disposed to have a ridge or a trough facing the light receiving plane (or incidence plane) of an integrator lens 71. The PBSs 3a and 3b is provided therebetween with a ½-wavelength retardation film 4, and on the ends thereof remote from the integrator lens 71 with a ¼-wavelength retardation film 5 coupled with a reflector 6 for reflecting light backward (inward).

In the arrangement shown in FIG. 2, substantially parallel beams of light emitted from one light source 1a enters the PBS 3a, where S-polarized component is first reflected by the light splitting plane 31a of the PBS 3a, while P-polarized component passes through the PBS 3a. The reflected S-polarized component then illuminates a first half domain of the incidence plane of the integrator lens 71. On the other hand, the P-polarized component transmitted through the PBS 3a gets S-polarized by the ½-wavelength retardation film 4, then reflected by the light splitting plane 31b of the PBS 3b, and twice modulated by the ¼-wavelength retardation film 5, once before and once after it is reflected back by the mirror 6. Thus, the resultant P-polarized light propagates in the same direction as the S-polarized light that is first reflected by the PBS 3a, and passes through the PBS 3b to enter a second half domain of the incidence plane of the integrator lens 71 in juxtaposition with the S-polarized light entering the first domain.

Similarly, substantially parallel beams of light emitted from the other light source 1b enters PBS 3b, where S-polarized component is first reflected by the light splitting plane 31b of the PBS 3b, while P-polarized component passes through the PBS 3b. The reflected S-polarized component illuminates the second half domain of the incidence plane of the integrator lens 71. On the other hand, the transmitted P-polarized component gets S-polarized by the ½-wavelength retardation film 4, then reflected by the light splitting plane 31a and twice modulated by the ¼-wavelength retardation film 5, once before and once after it is reflected back by the mirror 6. Thus, the resultant P-polarized light propagates in the same direction as the S-polarized light that is first reflected by the PBS 3b, and passes through the PBS 3a to enter the first half domain of the integrator lens 71 in juxtaposition with the P-polarized light entering the second domain.

Thus, in the lighting system 100, substantially parallel beams of light emitted from each of the light sources 1a and 1b can illuminate the entire incidence domain of the integrator lens 71. Therefore, if one of the two light sources 1a and 1b has burnt out toward the end of its life, the entire domain of the integrator lens 71 can be still well illuminated by the other light source, resulting in only reduced luminance inhomogeneity on the entire domain. Further, there is no need of accurate adjustment of optical components to correctly allocate substantially parallel beams of the light from the light sources to the respective domains of the integrator lens 71, as is needed in the prior art (Patent Document 2), thereby allowing easy assembly of the lighting system.

It will be appreciated that the two light sources 1a and 1b are disposed to face each other and that the light splitting planes 31a and 31b of the PBS 3a and 3b are adjoined to form a ridge or a trough facing the incidence plane of the integrator lens 71, which enables manufacture of the light-path alteration unit 2 at low cost.

Since the light splitting members consist of PBSs 3a and 3b, they can easily split substantially parallel beams of light emitted from each of the light sources 1a and 1b into S-polarized and P-polarized components and transmit one half of the beams while reflecting the other half beams.

In the example shown above the light splitting planes 31a and 31b of the PBSs 3a and 3b, respectively, are adjoined to form a ridge facing the integrator lens 71. Alternatively, the light splitting planes 31a and 31b can be adjoined to have a trough without changing other features of the arrangement.

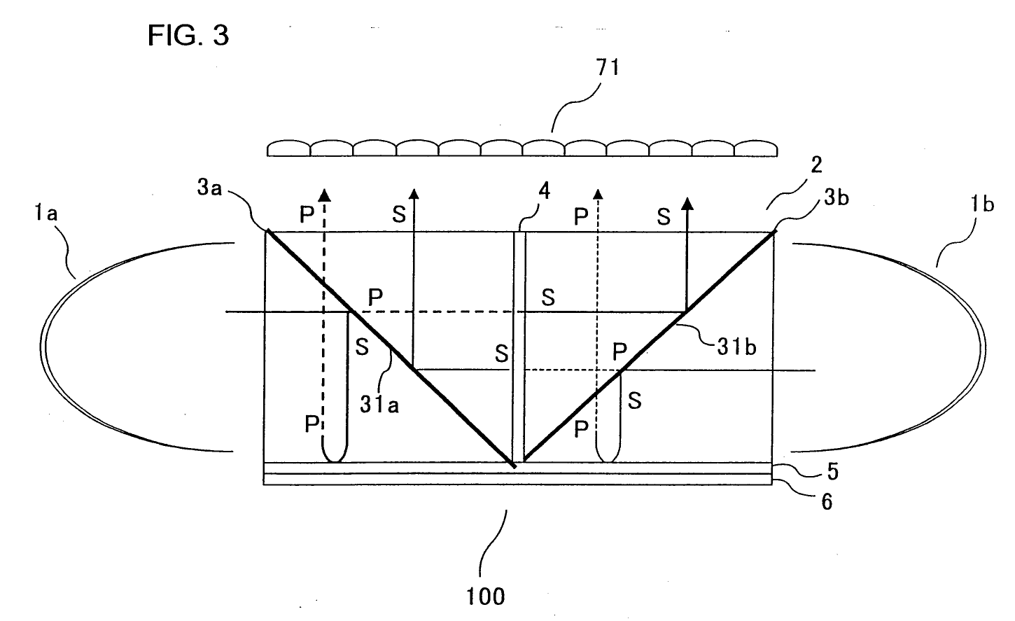

In the arrangement shown in FIG. 3, substantially parallel beams of light emitted from one light source 1a enters the PBS 3a, where S-polarized component is first reflected by the light splitting plane 31a of the PBS 3a, while P-polarized component passes through the PBS 3a. The P-polarized component transmitted through the PBS 3a gets S-polarized by the ½-wavelength retardation film 4, and reflected by the light splitting plane 31b of the PBS 3b onto the second half domain of the integrator lens 71. The reflected S-polarized component is twice modulated by the ¼-wavelength retardation film 5, once before and once after it is reflected back by the reflector 6, and results in P-polarized light that propagates in the same direction as the S-polarized component that is first reflected by the light splitting plane 31b. The resultant P-polarized component passes through the PBS 3a and enters the first half domain of the incidence plane of the integrator lens 71 in juxtaposition with the S-polarized beams.

On the other hand, substantially parallel beams of light emitted from the other light source 1b enter the PBS 3b, where the S-polarized component is first reflected by the light splitting planes 31b of the PBS 3b, while the P-polarized component passes through the PBS 3b. Subsequently, the P-polarized component gets S-polarized by the ½-wavelength retardation film 4, reflected by the light splitting plane 31a of the PBS 3a onto the first half domain of the integrator lens 71. The reflected S-polarized component is twice retarded by the ¼-wavelength retardation film 5, once before and once after it is reflected back by the reflector 6, resulting in P-polarized light that propagates in the same direction as the S-polarized component that is first reflected by the light splitting planes 31b. The P-polarized component passes through the PBS 3b and enters the second half domain of the incidence plane of the integrator lens 71 in juxtaposition with the resultant S-polarized beams.

Thus, in this arrangement also, each of the light sources 1a and 1b can irradiate the entire incidence domain of the integrator lens 71, so that the same result is obtained as in the foregoing embodiment.

Although the PBSs 3a and 3b are cubic in the embodiments above, slab-shaped PBSs can be used equally well in the lighting system.

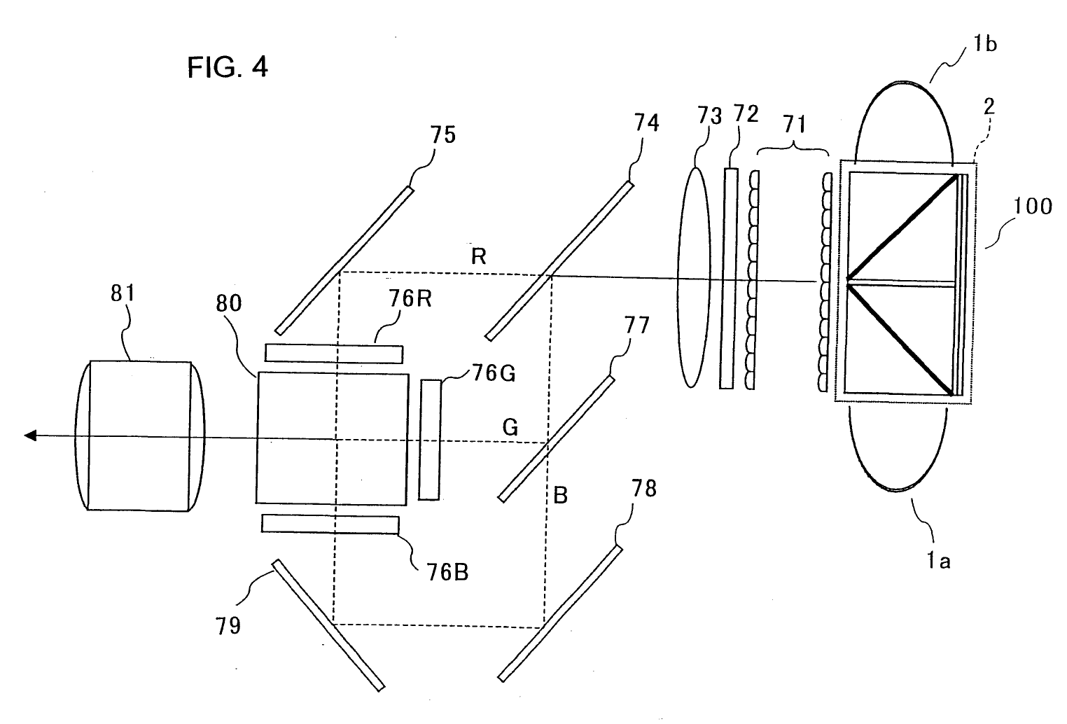

Referring to FIG. 4, there is shown a liquid crystal projector utilizing the lighting system shown in FIGS. 1 and 2.

The lighting system 100 of FIG. 4 emits white light for illuminating the integrator lens 71. After passing through the integrator lens 71, the white light enters a polarization converter 72. The integrator lens 71 consists of two groups of lenses, with each lens being designed to entirely illuminate each light receiving surface of the respective liquid crystal panels (described below) with averaged luminance inhomogeneity inherent to the lighting system 100, thereby minimizing the luminance difference between the central and peripheral regions of each liquid crystal panel. It is noted that the function of the lighting system 100 as described above to reduce luminance inhomogeneity is synergistically enhanced by the integrator lens 71.

The beams of light entering the polarization converter 72 gets uni-polarized by the polarization converter 72 and led to a first dichroic mirror 74 via a condenser lens 73. The first dichroic mirror 74 transmits red light R in the red wavelength zone and reflects light in the cyanogen (green+blue) wavelength zone. The red light R that has passed through the first dichroic mirror 74 is reflected by a total reflection mirror 75 to a liquid crystal panel 76R, where the light is optically modulated.

On the other hand, the light in the cyanogen wavelength zone reflected from the first dichroic mirror 74 is led to a second dichroic mirror 77. The second dichroic mirror 77 transmits light B in the blue wavelength zone and reflects light G in the green wavelength zone. The reflected green light G from the second dichroic mirror 77 is led to a penetration-type liquid crystal panel 76G for green light, where the light is optically modulated.

After passing through the second dichroic mirror 77, the blue light B is reflected by total reflection mirrors 78 and 79 onto a penetration-type liquid crystal panel 76B, where the light is optically modulated.

After being modulated in the respective liquid crystal panels 76R, 76G, and 76B, the resultant beams of light R, G, and B (each becoming image light for that color) are synthesized by a dichroic prism 80 to construct a beam of full color image light. This full color image light is projected by a projection lens unit 81 onto a screen (not shown).

In this liquid crystal projector, substantially parallel beams of light emitted from each light source (1a and 1b) of the lighting system 100 illuminates the entire illumination domain of the integrator lens 71, which causes the integrator lens 71 to perform its function as described above, thereby reducing the luminance inhomogeneity and color heterogeneity of the light sources even when one of the light sources has burnt out toward the end of its life. Further, since no precision adjustment of the lighting system is needed to allocate split beams of light to corresponding domains of the integrator lens 71, as is required in the prior art projector (Patent Document 2) cited above, components of the projector can be assembled in a simple manner.

It would be apparent that although the invention has been described above with reference to the lighting system having only two light sources 1a and 1b, more than two light sources could be included in the lighting system. For example, the lighting system 100 as a whole having two light sources 1a and 1b can be used as a light source of a lighting system.

In the first and second embodiments above, the invention has been described with reference to a projection type video display apparatus in the form of a liquid crystal projector utilizing liquid crystal panels. However, the invention can be equally applied to different projection type video display apparatuses that utilize other image generation systems, including a projector employing Digital Light Processing (DLP), which is a registered trademark of Texas Instruments (TI), Inc.

1. A lighting system, comprising:
a multiplicity of light sources for emitting substantially parallel beams of light;
a light-path alteration unit having light splitting members each adapted to reflect one half of the substantially parallel beams of light emitted from the light source associated therewith and transmit the other half of the beams therethrough, the light-path alteration unit collimating the light from the respective light sources in one direction to irradiate the entire illumination domain of a given integrator lens.

2. The lighting system according to claim 1, wherein
the multiplicity of light sources includes two opposing light sources facing each other; and
the light splitting members each having a light splitting plane associated with one light source and inclined to the illumination domain such that the two light splitting planes are adjoined to have a ridge or a trough facing the illumination domain.

3. The lighting system according to claim 1 or claim 2, wherein light splitting members are polarization beam splitters.

4. A lighting system, comprising:
a first and a second light source facing each other to emit substantially parallel beams of light;
a first and a second PBS coat which are inclined and disposed substantially symmetric between the first and second light sources, each PBS coat adapted to transmit P-polarized light emitted from the respective sources and reflect S-polarized light;
a first retardation film for converting into S-polarized light the P-polarized light that has passed through the first PBS coat and the P-polarized light that has passed through the second PBS coat;
a second retardation film and a mirror for converting into P-polarized light the S-polarized light that has been retarded by the first retardation film and reflected by the second or the first PBS coat, and for reflecting back the resultant P-polarized light; and
an integrator lens for receiving:
the S-polarized light first reflected by the first PBS coat and first reflected by the second PBS coat; and
the P-polarized light reflected from the mirror coupled with the second retardation film and transmitted through the second or the first PBS coat,
to thereby provide parallel beams of light having a substantially uniform intensity distribution.

5. A lighting system, comprising:
a first and a second light source facing each other to emit substantially parallel beams of light;
a first and a second PBS coat which are inclined and disposed substantially symmetric between the first and second light sources, each PBS coat adapted to transmit P-polarized light emitted from the respective sources and reflect S-polarized light;
a first retardation film for converting into S-polarized light the P-polarized light that has passed through the first PBS coat and the P-polarized light that has passed through the second PBS coat;
a second retardation film and a mirror for converting into P-polarized light the S-polarized light that has been retarded by the first retardation film and reflected by the second or the first PBS coat, and for reflecting back the resultant P-polarized light; and
an integrator lens for receiving:
the S-polarized light that is converted from the P-polarized light by the first retardation film and reflected by the second or first PBS coat and
the P-polarized light that is reflected from the mirror coupled with the second retardation film and transmitted through the first or second PBS coat,
to thereby provide substantially parallel beams of light having a substantially uniform intensity distribution.

6. The lighting system according to claim 4 or claim 5, wherein the first and second PBS coats are disposed substantially symmetric between the first and second light sources.

7. A projection type video display apparatus, comprising:
a lighting system according to claim 1;
optical modulation elements for modulating light emitted from the lighting system based on video signals; and
a projection lens unit for projecting the light modulated by the optical modulation elements.

8. The projection type video display apparatus according to claim 7, adapted to:
split the light received from the lighting system into three beams of primary colors and direct the respective split beams to associated optical modulation elements to modulate the respective split beams;
synthesize the modulated beams; and
project the synthesized beam.
